(19) United States
(12) Patent Application Publication
(10) Pub. No.: US 2010/0050416 A1
(43) Pub. Date: Mar. 4, 2010

(54) LOCATING DEVICE FOR PREASSEMBLING FASTENERS TO COMPONENTS AND METHOD OF ASSEMBLING COMPONENTS

(75) Inventors: David T. Renke, Macomb, MI (US); Eric W. Todd, Clinton Township, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/203,227

(22) Filed: Sep. 3, 2008

(51) Int. Cl. B23Q 3/18

(52) U.S. Cl. 29/468; 29/700

(57) ABSTRACT

A locating device for use with a first component fastenable to a second component by a fastener has a tab configured to be mounted with respect to the fastener when the fastener extends through an opening in the second component to retain the fastener to the second component. A method of assembling components is also provided.

### TECHNICAL FIELD

The invention relates to components attachable to one another with fasteners.

### BACKGROUND OF THE INVENTION

Complex assemblies require a careful ordering of steps to ensure that all components are efficiently and accurately assembled to one another. Often, fasteners, such as bolts and screws are used to hold components of the assembly together. The components must be accurately positioned relative to one another to allow the fasteners to be extended through mating openings in the components, and then tightened to attach the components. In a manufacturing setting, it is critical to adopt an efficient process that may be carried out in an ergonomic manner.

### SUMMARY OF THE INVENTION

A locating device for use with a first component fastenable to a second component by a fastener is provided with a tab configured to be mounted with respect to the fastener when the fastener extends through an opening in the second component to retain the fastener to the second component. This allows a preassembly of the fastener, tab and second component to be handled as a unit when retaining and securing the first component to the second component, reducing the handling of loose fasteners and associated manufacturing inefficiencies. The tab is configured to contact the first component at a mating opening in the first component, which may have a generally “keyhole” shape, to bias the fastener against the first component at the mating opening, thereby retaining the fastener to the first component within the mating opening prior to tightening the fastener to secure the first component to the second component. Once the bolt is tightened, the first and second components, fastener and tab are securely assembled to one another. In different embodiments, the tab may be integral or separate from the second component, and may have an extension that acts as an anti-rotation feature.

The locating device and opening in the first component act as complementary locating features enabling a net assembly method. “Net assembly” of components uses locating features (also referred to as positioning features, marking features, identifiers or alignment features) to angularly locate and fix components to one another, without “locking” the positions of any of the components until the assembly is completed. A net assembly method is relatively easy because of the locating features.

The locating device described above allows a method of assembling components that includes mounting a locating device with respect to a fastener when the fastener is retained to an assembly component to preassemble the fastener, the locating device and the assembly component to one another; wherein the locating device is configured to retain the fastener within the opening in the additional component when the fastener is placed in the opening of the additional component. The method may also include placing the fastener through the opening in the additional component, and contacting the additional component with the locating device at the opening, thereby biasing the fastener to be retained within the opening to thereby retain the fastener and the assembly component to the additional component. Next, the fastener may be tightened to thereby secure the assembly component to the additional component. If the tab includes an extension portion, the method may further include placing the extension portion of the locating device through an additional opening in the assembly component to prevent relative rotation of the assembly component and the additional component prior to the tightening of the fastener.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration in plan view of a first embodiment of a first component with a mating opening;

FIG. 2 is a schematic cross-section illustration of a first embodiment of an assembly of the first component of FIG. 1 retained to a second component including a locating device and a fastener;

FIG. 3 is a schematic perspective illustration of the fastener and second component with locating device preassembled to one another before being assembled to the first component in FIG. 2;

FIG. 4 is a schematic perspective illustration of a second embodiment of a fastener and a second component with a second embodiment of a locating device preassembled to one another;

FIG. 5 is a schematic cross-section illustration of the preassembled components of FIG. 4 assembled with a second embodiment of a first component;

FIG. 6 is a schematic cross-section illustration of a third embodiment of an assembly of a third embodiment of a first component assembled to a second component including a third embodiment of a locating device and a fastener;

FIG. 7 is a schematic perspective illustration of the locating device of FIG. 6;

FIG. 8 is a schematic perspective illustration of the second component, locating device, and fastener of FIG. 6 preassembled to one another;

FIG. 9 is a schematic illustration in plan view of a fourth embodiment of a first component with a mating opening;

FIG. 10 is a schematic cross-section illustration of the fourth embodiment of an assembly of the first component of FIG. 9 assembled to a second component including a fourth embodiment of a locating device and a fastener; and

FIG. 11 is a schematic perspective illustration of the second component, locating device, and fastener of FIG. 10 preassembled to one another.

### DESCRIPTION OF THE PREFERRED EMBODIMENTS

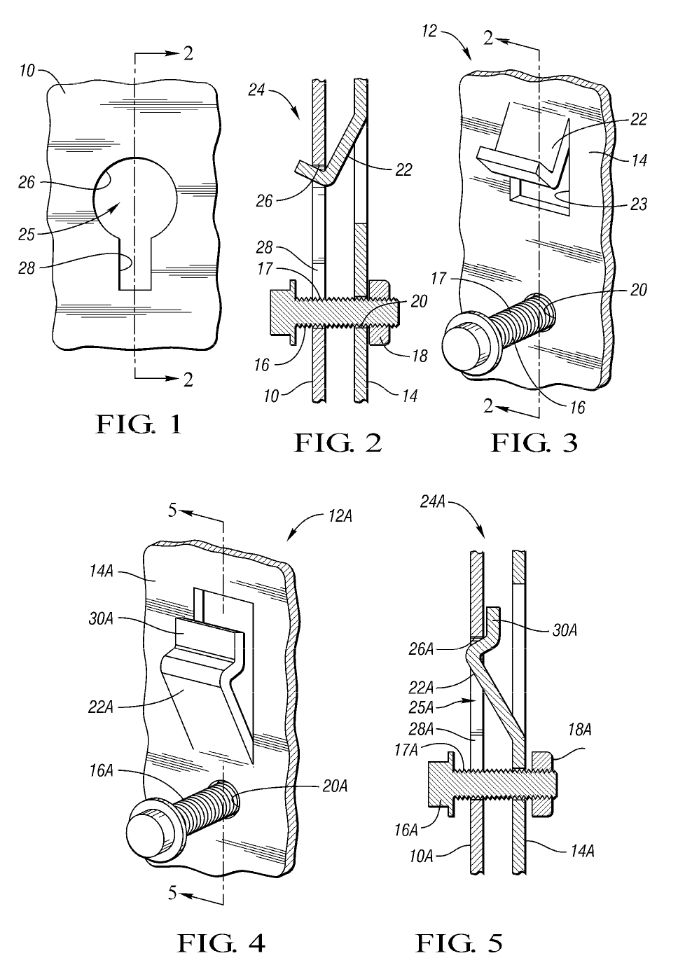

Referring to the drawings, wherein like reference numbers refer to like components, FIG. 1 shows a first component 10 configured to be secured to the assembly 12 of FIG. 3 as illustrated in FIG. 2. The assembly 12 of FIG. 3 includes a second component 14, a fastener 16, that includes a bolt 17 and a nut 18 retained to the second component 14 through a fastener opening 20 in the second component, and a locating device, also referred to herein as a tab 22 or spring clip. The first component 10 is also referred to herein as an additional component, and the second component 14 is also referred to as an assembly component.

In this embodiment, the tab 22 is integral with the second component 14. The second component 14 is a sheet metal component, such as a window regulator in a vehicle. The tab 22 is a portion of the second component 14 that is punched outward, leaving a window or tab opening 23. In other embodiments within the scope of the claimed invention, the second component 14 may be a plastic or other material with a tab integrally formed thereto, such as by molding the entire component with tab, such that no tab opening exists. In still other embodiments, as described herein, a tab is provided that is separate from (i.e., not integral with) a second component.

The preassembled second component 14, tab 22 and fastener 16 are easily retained to the first component 10, as illustrated in FIG. 2 prior to tightening of the bolt 17 to secure the first component 10 to the second component 14. Preassembly of the fastener 16 to the second component 14 allows the second component 14 to be retained and secured to the first component 10 without the assembler needing to handle any loose fasteners. Avoiding loose fasteners minimizes the possibility of dropped fasteners and increases manufacturing efficiency. Once retained by the tab 22 and fastener 16, an assembly 24 of the first component 10, the second component 14 with tab 22 and fastener 16 is secured by tightening the fastener 16.

The configuration of the tab 22 ensures the retention of the fastener 16 in the correct position when inserted through a mating opening 25 in the first component 10. Specifically, the assembly 12 is retained to the first component 10 by extending the fastener 16 through the mating opening 25. The tab 22 is then positioned to contact the first component 10 at a main portion 26 of the opening 25 which forces the fastener 16 to be retained within a slot 28 of the mating opening 25, as shown in FIG. 2. The slot 28 is also referred to as a narrowed portion. As is apparent in FIG. 1, the mating opening 25 has a shape typically referred to as a “keyhole”, with the main portion 26 being generally circular and the slot 28 general extending from the main portion 26.

Thus, a method of assembling the assembly 24 of FIG. 2 includes mounting a locating device 22 with respect to a fastener 16 when the fastener 16 is retained to the second component 14 to thereby preassemble these components to one another, as illustrated in FIG. 3. Thus, the assembly 12 can be handled in the assembly area as a unit, and can be retained to the first component 10 by placing the fastener 16 through the mating opening 25 and contacting the first component 10 with the tab 22 at the main portion 26 of the opening 25. The preconfigured spacing of the opening 20 and the tab 22 biases the fastener 16 to be retained in the slot 28 of opening 25 when the tab 22 is placed in contact with the first component 10 at opening 25. The fastener 16 can then be tightened to secure the first and second components 10, 14 to one another.

Prior to tightening the fastener 16, the tab 22 operates as a “net assembly” locating feature in that the first and second components 10, 14 are positioned relative to each other, but some adjustment of their relative positions is permitted. This method of assembly is especially useful when securing components to one another at multiple locations with multiple fasteners. For example, if a second tab 22 is provided elsewhere on the second component 14 and is configured to be retained to the first component at another opening, or even to a third component with another fastener, both of the fasteners could be used to assemble the first and second components 10, 14 to one another using the respective tabs 22. Some play or adjustment of the relative positions of the first and second components 10, 14 would be possible, as the tabs 22 have some spring-like ability, and could compress more closely to the second component 14 when contacting the first component 10. The respective fasteners 16 could be retained slightly higher or lower within the slot 28, as needed, to allow for manufacturing tolerance stack up of the relative location of the multiple openings in the first and second components 10, 14.

Referring to FIGS. 4 and 5, a second embodiment of a locating device or tab 22A is used with a fastener 16A to retain a first component 10A to a second component 14A prior to tightening the fastener 16A. The fastener 16A includes a bolt 17A and a nut 18A. The tab 22A is integral with the second component 14A. A fastener opening 20A is also provided in the second component 14A, and the fastener 16A with the tab 22A mounted with respect to the fastener 16A is retained to the second component 14A and tab 22A as an assembly 12A as shown in FIG. 4, prior to being retained to the first component 10A. The first component 10A has a mating opening 25A with a main portion 26A and a slot 28A shown only in cross-section in FIG. 5 but having a substantially identical shape to the opening 25 of FIG. 1. Thus, the assembly 12A can be retained to the first component 10A and then secured thereto by tightening the bolt 17A according to the method described above with respect to similarly numbered components of FIGS. 1-3 to form assembly 24A. Additionally, the tab 22A has a back support portion 30A that may provide additional biasing force slightly urging the first component 10A away from the second component 14A to help prevent over tightening of the fastener 16A.

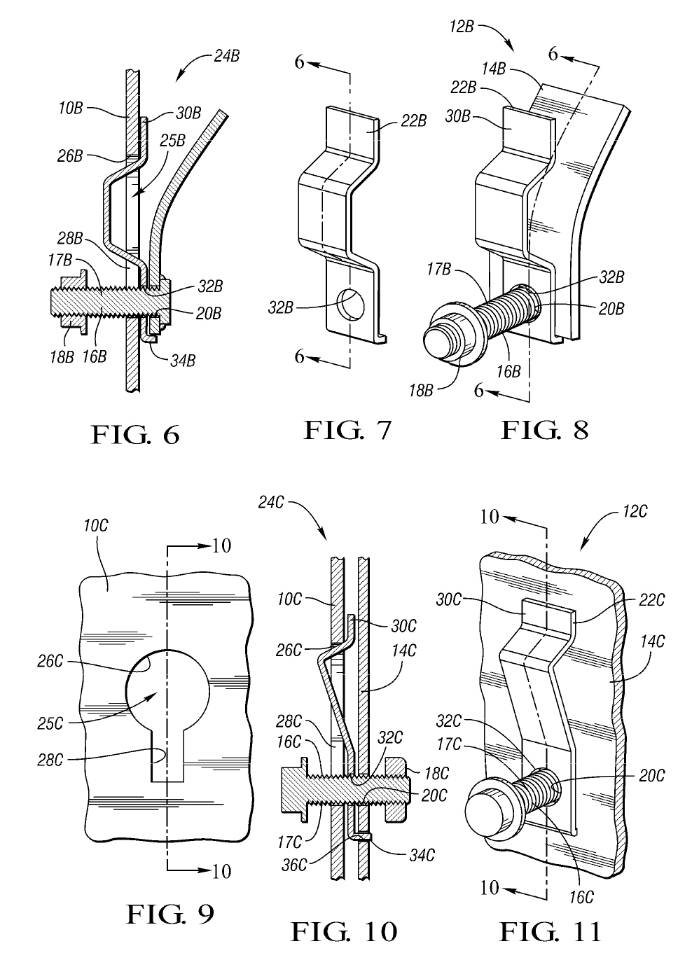

Referring to FIGS. 6-8 a third embodiment of a locating device or tab 22B is used with a fastener 16B to retain a first component 10B to a second component 14B prior to tightening the fastener 16B. The fastener 16B includes a bolt 17B and a nut 18B. Unlike the first and second embodiments discussed above, the tab 22B is not integral with the second component 14B. The fastener 16B, tab 22B and second component 14B may be preassembled to one another by inserting the fastener 16B through a fastener opening 32B provided in the tab 22B and then through a fastener opening 20B in the second component 14B to preassemble these components to one another as assembly 12B and thereby mount the tab 22B with respect to the fastener 16B. When assembled to the first component 10B, the tab 22B is configured to contact the first component 10B at the main portion 26B of opening 25B in the first component 10B to bias the fastener 16B into a slot 28B of the opening 25B, helping to retain the fastener 16B and second component 14B to the first component 10B prior to tightening the fastener 16B to form assembly 24B. Similar to tab 22A of FIG. 5, tab 22B has a back support portion 30B that may provide additional biasing force slightly urging the first component 10B away from the second component 14B to help prevent over tightening of the fastener 16B. Additionally, the tab 22B has an extension 34B configured to contact the second component 14B to prevent rotation of the second component 14B relative to the first component 10B prior to tightening the fastener 16B. The extension 34B acts as a barrier, disposed as a horizontal shelf in FIG. 6, to prevent rotation of the second component 14B about the fastener 16B.

Referring to FIGS. 9-11 a fourth embodiment of a locating device or tab 22C is used with a fastener 16C to retain a first component 10C to a second component 14C prior to tightening the fastener 16C. The fastener 16C includes a bolt 17C and a nut 18C. Like the third embodiment discussed above, the tab 22C is not integral with the second component 14C. The fastener 16C, tab 22C and second component 14C may be preassembled to one another by inserting the fastener 16C through a fastener opening 32C provided in the tab 22C and then through a fastener opening 20C in the second component 14C to preassemble these components to one another as assembly 12C shown in FIG. 11. Thus, the tab 22C is mounted with respect to the fastener 16C. When preassembled, the tab 22C is configured to contact the first component 10C at the main portion 26C of opening 25C in the first component 10C to bias the fastener 16C into a slot 28C of the opening 25C, helping to retain the fastener 16C and second component 14C to the first component 10C prior to tightening the fastener 16C to form assembly 24C. Similar to tab 22A of FIG. 5, tab 22C has a back support portion 30C that may provide additional biasing force slightly urging the first component 10C away from the second component 14C to help prevent over tightening of the fastener 16C. Additionally, the tab 22C has an extension 34C configured to contact the second component 14C to prevent relative rotation of the second component 14C relative to the first component 10C prior to tightening the fastener 16B. The extension 34C is configured to be inserted through an additional opening 36C in the second component 14C spaced from the opening 20C so that the tab 22C contacts the first component 10C at the main portion 26C of the opening 25C when the extension 34C fits through the opening 36. The extension 36C helps to prevent rotation of the tab 22C, thereby further stabilizing the relative positions of the first component 10C and second component 14C prior to tightening the fastener 16C.

Thus, the locating features or tabs 22-22C described above, along with the mating openings 25-25C permit preassembly of the fasteners 16-16C to the second components 14-14C, prior to retaining the fasteners 16-16C to the first components 10-10C and tightening to secure the first and second components to one another. Loose components are minimized to help maintain manufacturing efficiency.

While the best modes for carrying out the invention have been described in detail, those familiar with the art to which this invention relates will recognize various alternative designs and embodiments for practicing the invention within the scope of the appended claims.

1. A locating device for use with a first component fastenable to a second component by a fastener, comprising:
a tab configured to be mounted with respect to the fastener when the fastener extends through an opening in the second component to retain the fastener to the second component; wherein the tab is configured to contact the first component at a mating opening in the first component to bias the fastener against the first component at the mating opening, thereby retaining the fastener to the first component within the mating opening prior to tightening the fastener to secure the first component to the second component.

2. The locating device of claim 1, wherein the mating opening has a main portion with a slot extending therefrom, the slot being narrower than the main portion; and wherein the tab is configured to contact the first component at the main portion and bias the fastener against the first component within the slot.

3. The locating device of claim 1, wherein the second component has an additional opening adjacent the opening; and wherein the tab has an extension configured to extend through the additional opening to prevent relative rotation of the first component to the second component when the tab is mounted with respect to the fastener and the fastener is retained to the first component within the mating opening by the tab.

4. The locating device of claim 1, wherein the tab has an extension portion configured to contact the second component to substantially prevent relative rotation of the first and second components prior to tightening the fastener.

5. The locating device of claim 1, wherein the tab has a fastener opening sized to permit the fastener to extend therethrough when the tab is mounted with respect to the fastener.

6. The locating device of claim 1, wherein the tab is an integral portion of the second component.

7. An assembly comprising:
an assembly component;
an additional component having an opening with a narrowed portion;
a fastener retained to the assembly component; and
a tab configured to be mounted with respect to the fastener while contacting the additional component at the opening to bias the fastener against the additional component at the narrowed portion, thereby retaining the fastener to the additional component within the opening prior to tightening the fastener to secure the assembly component to the additional component.

8. The assembly of claim 7, wherein the opening with the narrowed portion is a generally circular opening with a narrower slot portion extending therefrom.

9. The assembly of claim 7, wherein the assembly component has an additional opening adjacent the opening; and wherein the tab has an extension configured to extend through the additional opening to substantially prevent relative rotation of the assembly component with respect to the additional component when the tab is retained on the fastener and the fastener is retained to the additional component within the narrowed portion of the opening.

10. The assembly of claim 7, wherein the tab has an extension portion configured to contact the assembly component to substantially prevent relative rotation of the additional and assembly components prior to tightening the fastener.

11. The assembly of claim 7, wherein the tab is an integral portion of the assembly component.

12. A method of assembling components, comprising:
mounting a locating device with respect to a fastener when the fastener is retained to an assembly component to preassemble the fastener, the locating device and the assembly component to one another; wherein the locating device is configured to retain the fastener within an opening in an additional component when the fastener is placed in the opening of the additional component.

13. The method of claim 12, further comprising:
placing the fastener through the opening in the additional component; and
contacting the additional component with the locating device at the opening, thereby biasing the fastener to be retained within the opening to thereby retain the fastener and the assembly component to the additional component.

14. The method of claim 12, further comprising:
tightening the fastener to thereby secure the assembly component to the additional component.

15. The method of claim 12, further comprising:
placing an extension portion of the locating device through an additional opening in the assembly component to prevent relative rotation of the assembly component and the additional component prior to the tightening of the fastener.
